(19) United States
(12) Patent Application Publication
(10) Pub. No.: US 2016/0129757 A1
(43) Pub. Date: May 12, 2016

(54) AIR CONDITIONING DEVICE FOR VEHICLE

(71) Applicant: Panasonic Intellectual Property Management Co., Ltd., Osaka (JP)

(72) Inventors: Yuji Kodera, Kanagawa (JP); Kentaro Kuroda, Kanagawa (JP); Katsuji Taniguchi, Kanagawa (JP); Tomohiro Terada, Kanagawa (JP); Yoshitoshi Noda, Kanagawa (JP)

(21) Appl. No.: 14/995,920

(22) Filed: Jan. 14, 2016

Related U.S. Application Data
(63) Continuation of application No. PCT/JP2014/003868, filed on Jul. 23, 2014.

(30) Foreign Application Priority Data
Jul. 26, 2013 (JP) 2013-155185

(51) Int. Cl. B60H 1/22; B60H 1/32

(52) U.S. Cl. CPC B60H 1/22; B60H 1/321; B60H 1/3213; B60H 1/3216; B60H 1/3225

(57) ABSTRACT

This air conditioning device for vehicle includes a first water-refrigerant heat exchanger which performs a heat exchange between a coolant and a low-temperature and low-pressure refrigerant, and vaporizes the refrigerant, a compressor which compresses the refrigerant fed from the first water-refrigerant heat exchanger, to a high-temperature and high-pressure refrigerant, and discharges the refrigerant, a heater core which heats an interior of a vehicle by using heat of the high-temperature and high-pressure refrigerant discharged by the compressor, a temperature sensor which detects a temperature of the coolant circulating in the first water-refrigerant heat exchanger and a cooling path of a heat generating component of the vehicle, the temperature being detected when the coolant flows in the first water-refrigerant heat exchanger, and a controller which determines whether or not to permit driving of the compressor, based on the temperature detected by the temperature sensor.

### RELATED APPLICATIONS

This application is a Continuation of International Application No. PCT/JP2014/003868, filed on Jul. 23, 2014, which in turn claims priority from Japanese Patent Application No. 2013-155185, filed on Jul. 26, 2013, the contents of all of which are incorporated herein by reference in their entireties.

### TECHNICAL FIELD

The present disclosure relates to an air conditioning device for vehicle.

### BACKGROUND

An air conditioning device for vehicle which adjusts air-conditioning in a vehicle needs to perform control such that a suction pressure of a compressor does not become a negative pressure in driving of the compressor which compresses and discharges a refrigerant. This is because, when the suction pressure of the compressor becomes the negative pressure, air enters a refrigerant pipe, a low-temperature refrigerant freezes moisture in air and the frozen moisture causes troubles such as damages of the compressor and jamming in a cycle.

Countermeasures for these troubles include that a pressure sensor measures a pressure at a suction side (see Unexamined Japanese Patent Publication No. 2003-267039) or a predetermined standby time is provided after an engine is driven and then a compressor is driven (see Unexamined Japanese Patent Publication No. 2000-142094).

### SUMMARY

An air conditioning device for vehicle according to the present disclosure employs a configuration including: a first water-refrigerant heat exchanger which performs a heat exchange between a coolant and a low-temperature and low-pressure refrigerant, and vaporizes the refrigerant; a compressor which compresses the refrigerant fed from the first water-refrigerant heat exchanger, to a high-temperature and high-pressure refrigerant, and discharges the refrigerant; a heater core which heats an interior of a vehicle by using heat of the high-temperature and high-pressure refrigerant discharged by a compressor; a temperature sensor which detects a temperature of the coolant circulating in the first water-refrigerant heat exchanger and a cooling path of a heat generating component of the vehicle, the temperature being detected when the coolant flows in the first water-refrigerant heat exchanger; and a controller which determines whether or not to permit driving of the compressor, based on the temperature detected by the temperature sensor.

### BRIEF DESCRIPTION OF DRAWINGS

FIG. 1 is a configuration diagram of an air conditioning device for vehicle according to a first exemplary embodiment of the present disclosure.

FIG. 2 is a diagram for illustrating an operation of a heat pump heating mode.

FIG. 3 is a diagram for illustrating an operation of a cooling mode.

FIG. 4 is a block diagram illustrating part of components of the air conditioning device for vehicle.

FIG. 5 is a flowchart illustrating an operation process of an air conditioning controller.

FIG. 6 is a flowchart illustrating a process of driving determination control of the air conditioning controller illustrated in FIG. 5.

FIG. 7 is a flowchart illustrating another process of driving determination control of the air conditioning controller illustrated in FIG. 5.

FIG. 8 is a flowchart illustrating a process of normal driving determination control of the air conditioning controller illustrated in FIG. 5.

FIG. 9 is a flowchart illustrating a process of refrigerant state determination control illustrated in FIG. 8.

FIG. 10A and FIG. 10B are diagrams for illustrating stagnation-resolving control processing according to a second exemplary embodiment of the present disclosure.

FIG. 11A and FIG. 11B are diagrams for illustrating stagnation-resolving control processing according to the second exemplary embodiment of the present disclosure.

### DESCRIPTION OF EMBODIMENTS

Prior to the description of an exemplary embodiment of the present disclosure, problems intend to solve are described as follows.

A technique disclosed in Unexamined Japanese Patent Publication No. 2003-267039 has a problem that the pressure sensor is additionally provided at the suction side of the compressor and therefore the cost increases. Further, the technique disclosed in Unexamined Japanese Patent Publication No. 2000-142094 has a problem that a timing to turn on the compressor is different depending on an amount of heat generation of an engine, and therefore it is difficult to set a predetermined time to turn off the compressor and it is not possible to take an efficient countermeasure for a negative pressure.

The present disclosure provides an air conditioning device for vehicle which suppresses an increase in cost and takes an efficient countermeasure for a negative pressure.

Exemplary embodiments of the present disclosure will be described below in detail with reference to the drawings.

### First Exemplary Embodiment

### <Configuration of Air Conditioning Device for Vehicle>

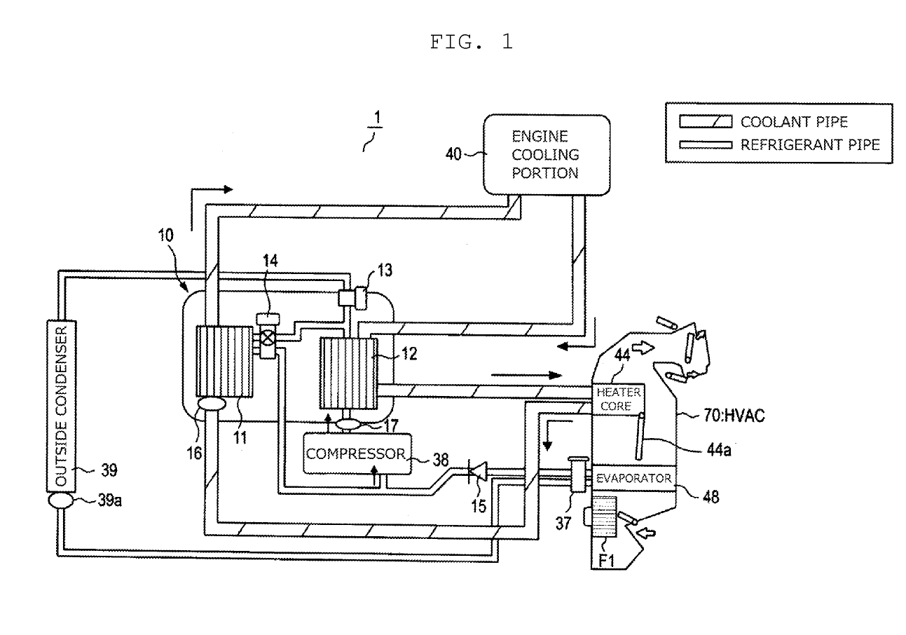

FIG. 1 is a configuration diagram of the air conditioning device for vehicle according to the first exemplary embodiment of the present disclosure.

Air conditioning device for vehicle 1 according to the first exemplary embodiment of the present disclosure is a device which is mounted on a vehicle including an engine (internal combustion engine) as a heat generating component, and adjusts air-conditioning in the vehicle.

Air conditioning device for vehicle 1 according to the exemplary embodiment includes constituent unit 10, compressor (compressing machine) 38, engine cooling portion 40, heater core 44, evaporator 48, expansion valve 37, outside condenser 39, check valve 15, coolant pipes which connect these components, and a refrigerant pipe. Heater core 44 and evaporator 48 are disposed in a suction air path of HVAC (Heating, Ventilation, and Air Conditioning) 70. HVAC 70 is provided with fan F1 which causes a suction air to flow.

Compressor 38 is driven by power of an engine or electricity, and compresses a suctioned refrigerant to a high-temperature and high-pressure refrigerant and discharges the refrigerant. The compressed refrigerant is fed to constituent unit 10. Compressor 38 suctions a low-pressure refrigerant through a junction pipe from evaporator 48 or first water-refrigerant heat exchanger 11 of constituent unit 10.

Engine cooling portion 40 includes a water jacket which causes a coolant to flow in surroundings of the engine, and a pump which causes the coolant to flow in the water jacket, and releases heat from the engine to the coolant flowing to the water jacket. The pump is rotated by, for example, power of the engine. Engine cooling portion 40 may include a radiator which releases heat to outside air when the amount of heat exhausted from the engine is large. A coolant path of engine cooling portion 40 passes through constituent unit 10 and is connected to heater core 44.

The coolant is, for example, an antifreeze liquid such as an LLC (Long Life Coolant) and is a liquid for heat transportation.

A configuration of transporting the coolant may include only the pump of engine cooling portion 40. Consequently, it is possible to reduce the cost of the air conditioning device and reduce an installation space for the air conditioning device. To enhance performance of transporting the coolant, a pump may be added to another portion of the coolant pipe.

Heater core 44 is a device which performs a heat exchange between a coolant and air, and is disposed in a suction air path of HVAC 70 which supplies air to the interior of the vehicle. Heater core 44 receives a supply of the heated coolant, and releases heat to a suction air fed to the interior of the vehicle (an air-blast to the interior of the vehicle) in a heating operation. Heater core 44 can adjust the amount of air which passes according to an opening of door 44a. Door 44a can be electrically controlled to open and close. Door 44a is also referred to as an air mix door.

Evaporator 48 is a device which performs a heat exchange between a low-temperature and low-pressure refrigerant and air, and is disposed in the suction air path of HVAC 70. Evaporator 48 receives a flow of a low-temperature and low-pressure refrigerant in a cooling operation or a dehumidifying operation, and cools suction air supplied to the interior of the vehicle (an air-blast to the interior of the vehicle).

Expansion valve 37 expands a high-pressure refrigerant to a low-temperature and low-pressure refrigerant, and discharges the refrigerant to evaporator 48. Expansion valve 37 is disposed close to evaporator 48. Expansion valve 37 may have a function of automatically adjusting the amount of refrigerant to discharge according to a temperature of a refrigerant fed from evaporator 48.

Outside condenser 39 includes a path in which a refrigerant flows and a path in which air flows, is disposed at a head of the vehicle in an engine room and performs a heat exchange between the refrigerant and outside air. Outside condenser 39 receives a flow of a high-temperature and high-pressure refrigerant in the cooling mode and the dehumidifying mode, and exhausts heat from the refrigerant to outside air. Outside air is blown to outside condenser 39 by, for example, a fan. Reservoir tank 39a may be provided at a side of outside condenser 39 from which the refrigerant is fed.

Constituent unit 10 is an integrated component which is manufactured as a single unit at a factory, and is connected with other components of air conditioning device for vehicle 1 by pipes in a vehicle assembly process. In constituent unit 10, each component may be housed in one housing and integrated or each component may be integrated by being jointed.

Constituent unit 10 includes first water-refrigerant heat exchanger 11, second water-refrigerant heat exchanger 12, ON-OFF valve (corresponding to first switch) 13, and solenoid valve equipped expansion valve (corresponding to a second switch, an expansion valve having ON-OFF function) 14.

First water-refrigerant heat exchanger 11 (evaporator) includes a path in which the low-temperature and low-pressure refrigerant flows and a path in which a coolant flows, and performs heat exchange between the refrigerant and the coolant. In first water-refrigerant heat exchanger 11, solenoid valve equipped expansion valve 14 discharges the low-temperature and low-pressure refrigerant in a predetermined operation mode to transfer heat from the coolant to the low-temperature and low-pressure refrigerant. Thus, first water-refrigerant heat exchanger 11 vaporizes the low-temperature and low-pressure refrigerant.

A coolant inlet of first water-refrigerant heat exchanger 11 is connected to heater core 44 through a pipe, and a coolant outlet is connected to engine cooling portion 40 through a pipe. The refrigerant inlet of first water-refrigerant heat exchanger 11 is connected to solenoid valve equipped expansion valve 14 through a pipe, and the refrigerant outlet is connected to a pipe which joins a suction port of compressor 38.

Second water-refrigerant heat exchanger 12 (condenser) includes a path in which the high-temperature and high-pressure refrigerant flows and a path in which a coolant flows, and performs a heat exchange between the refrigerant and the coolant. Second water-refrigerant heat exchanger 12 receives a flow of the high-temperature and high-pressure refrigerant fed from compressor 38 in a predetermined operation mode, and exhausts heat to the coolant from the high-temperature and high-pressure refrigerant. Thus, second water-refrigerant heat exchanger 12 condenses the high-temperature and high-pressure refrigerant.

A coolant inlet of second water-refrigerant heat exchanger 12 is connected to engine cooling portion 40 through a pipe, and a coolant outlet is connected to heater core 44 through a pipe. The refrigerant inlet of second water-refrigerant heat exchanger 12 is connected to a discharge port of compressor 38 through a pipe, and the refrigerant outlet is connected to

ON-OFF valve 13 and solenoid valve equipped expansion valve 14 through a branching pipe.

ON-OFF valve 13 is a valve which is, for example, electrically controlled to open and close a refrigerant pipe. ON-OFF valve 13 is, for example, a solenoid valve.

Solenoid valve equipped expansion valve 14 is a valve which is, for example, electrically controlled to switch to open or close the refrigerant pipe, and functions as an expansion valve when the refrigerant pipe is opened. Solenoid valve equipped expansion valve 14 may be a thermal expansion valve (TXV) which automatically adjusts a refrigerant flow rate based on a refrigerant temperature of the refrigerant outlet of first water-refrigerant heat exchanger 11 when functioning as the expansion valve.

Check valve 15 is a valve which is provided between compressor 38 and evaporator 48, and prevents a reverse flow of the refrigerant in an operation mode in which the refrigerant does not flow to outside condenser 39 and evaporator 48. In this regard, an operation mode in which ON-OFF valve 13 is closed and the refrigerant flows to a refrigerant circuit which passes through first water-refrigerant heat exchanger 11 and second water-refrigerant heat exchanger 12 will be considered. In this operation mode, ON-OFF valve 13 is closed, and therefore the refrigerant circuit passing through outside condenser 39 and evaporator 48 is interrupted. However, even in this case, when the temperature of outside air is low, a refrigerant pressure in outside condenser 39 and evaporator 48 lowers in some cases. Further, when the pressure lowers in this way, the refrigerant flowing to the refrigerant circuit of first water-refrigerant heat exchanger 11 and second water-refrigerant heat exchanger 12 reversely flows to the refrigerant circuit at a side of evaporator 48. As a result, the amount of refrigerant in the refrigerant circuit passing through first water-refrigerant heat exchanger 11 and second water-refrigerant heat exchanger 12 deviates from an optimal range, and efficiency of this heat pump cycle lowers. However, check valve 15 is provided, so that it is possible to avoid such inconvenience.

Temperature sensor 16 is provided on a coolant path through which a coolant is guided to first water-refrigerant heat exchanger 11, and detects a temperature of the coolant guided to first water-refrigerant heat exchanger 11. In this regard, even when temperature sensor 16 is provided at any position of the coolant path, it is possible to provide the effect of the present exemplary embodiment. In addition, air conditioning device for vehicle 1 which cools a heat generating component of the vehicle by using a coolant generally includes temperature sensor 16.

Discharge pressure sensor 17 is provided on a discharge-side refrigerant pipe of compressor 38, and detects a pressure of a refrigerant discharged from compressor 38. In addition, discharge pressure sensor 17 is preferably disposed near a discharge port of compressor 38. However, discharge pressure sensor 17 does not need to be disposed near the discharge port of compressor 38 as long as a pressure of a refrigerant at the discharge side of compressor 38. For example, it is also possible to provide it on a pipe for a refrigerant fed from second water-refrigerant heat exchanger 12.

### <Operation of Air Conditioning Device for Vehicle>

Next, an operation of air conditioning device for vehicle 1 will be described.

Air conditioning device for vehicle 1 operates by being switched to some operation modes such as a hot water heating mode, a heat pump heating mode, a temperature adjusting mode, and a cooling mode. The hot water heating mode is a mode of heating the interior of the vehicle without operating the heat pump. The heat pump heating mode is a mode of heating the interior of the vehicle by operating the heat pump. The cooling mode is a mode of cooling the interior of the vehicle by an operation of the heat pump. A temperature adjusting mode is a mode of adjusting the temperature and the humidity of air by optionally cooling and dehumidifying air by using the low-temperature refrigerant, and heating air by using the high-temperature coolant. The heat pump heating mode and the cooling mode will be described below as typical examples.

### [Heat Pump Heating Mode]

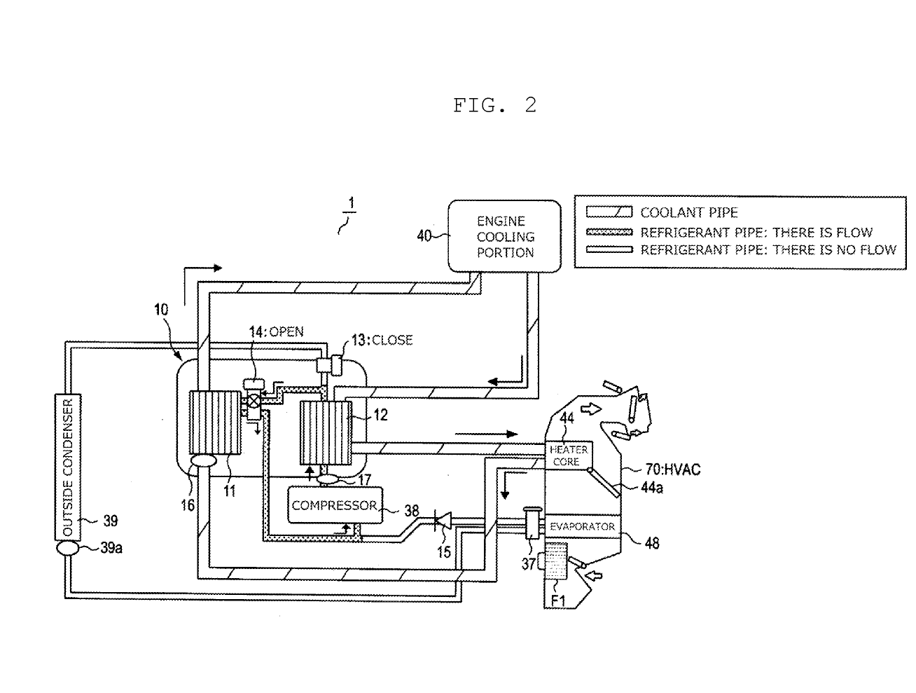

FIG. 2 is a diagram for illustrating an operation of a heat pump heating mode.

In the heat pump heating mode, as illustrated in FIG. 2, ON-OFF valve 13 is switched to close, and solenoid valve equipped expansion valve 14 is switched to open (thermal expansion valve operation). Further, door 44a of heater core 44 is opened (fully opened, for example).

In the heat pump heating mode, when compressor 38 further operates, the refrigerant circulates in order of second water-refrigerant heat exchanger 12, solenoid valve equipped expansion valve 14, first water-refrigerant heat exchanger 11, and compressor 38.

In this regard, the high-temperature and high-pressure refrigerant compressed by compressor 38 releases heat to the coolant in second water-refrigerant heat exchanger 12 and the refrigerant condenses. The condensed refrigerant is expanded to the low-temperature and low-pressure refrigerant by solenoid valve equipped expansion valve 14, and is fed to first water-refrigerant heat exchanger 11. The low-temperature and low-pressure refrigerant absorbs heat from the coolant in first water-refrigerant heat exchanger 11 and the refrigerant vaporizes. The vaporized low-pressure refrigerant is suctioned and is compressed by compressor 38.

The coolant circulates in order of engine cooling portion 40, second water-refrigerant heat exchanger 12, heater core 44, and first water-refrigerant heat exchanger 11.

In this regard, the coolant having heat absorbed from the engine in engine cooling portion 40 is further heated by second water-refrigerant heat exchanger 12 and is fed to heater core 44. In heater core 44, the coolant whose temperature has become high can sufficiently heat suction air fed to the interior of the vehicle.

The coolant having passed through heater core 44 has a higher temperature than outside air, and can release heat to the refrigerant and vaporizes the refrigerant in first water-refrigerant heat exchanger 11. The coolant having been cooled by first water-refrigerant heat exchanger 11 is fed to engine cooling portion 40 and can sufficiently cool the engine.

With this operation, it is possible to sufficiently warm the interior of the vehicle.

### [Cooling Mode]

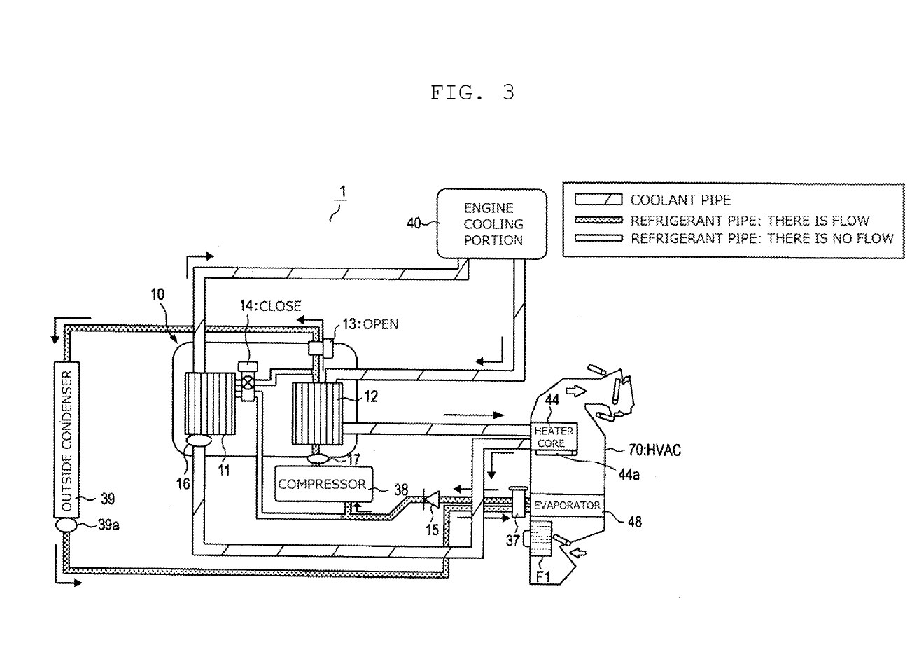

FIG. 3 is a diagram for illustrating an operation of the cooling mode.

In the cooling mode, as illustrated in FIG. 3, ON-OFF valve 13 is switched to open and solenoid valve equipped expansion valve 14 is switched to close. Further, door 44a of heater core 44 is fully closed.

In the cooling mode, when compressor 38 further operates, the refrigerant circulates in order of second water-refrigerant heat exchanger 12, outside condenser 39, expansion valve 37, evaporator 48, and compressor 38.

The coolant flows in engine cooling portion 40, second water-refrigerant heat exchanger 12, heater core 44, and first water-refrigerant heat exchanger 11. The coolant is not cooled in first water-refrigerant heat exchanger 11, and therefore has a relatively higher temperature. Heat is released from the coolant mainly by a radiator of engine cooling portion 40. The temperature of the engine becomes very high, and therefore even when an outside air temperature is high, it is possible to adequately cool the interior of the vehicle by heat release from the radiator. In this regard, a configuration of causing the coolant to flow may make a more coolant flow than to heater core 44 by lowering a coolant flow to heater core 44.

The high-temperature and high-pressure refrigerant compressed by compressor 38 hardly releases heat in second water-refrigerant heat exchanger 12 since a temperature of the coolant in second water-refrigerant heat exchanger 12 is high. The high-temperature and high-pressure refrigerant is then fed to outside condenser 39, is released to air, and condenses.

The condensed refrigerant is fed to evaporator 48. The refrigerant, at first, expands at expansion valve 37 to become a low-temperature and low-pressure refrigerant, and then cools an air-blast to the interior of the vehicle at evaporator 48. The refrigerant is vaporized by this heat exchange. The vaporized low-pressure refrigerant is suctioned and is compressed by compressor 38.

With this operation, it is possible to sufficiently cool the interior of the vehicle.

When a heat pump operation is performed while the amount of refrigerant is small, cooling and heating performance lowers. Hence, it is necessary to detect leakage of the refrigerant. A case where air conditioning device for vehicle 1 detects leakage of the refrigerant in the heat pump operation will be described below.

### <Main Function Block of Air Conditioning Device for Vehicle>

Next, the main function block of air conditioning device for vehicle 1 according to the exemplary embodiment will be described.

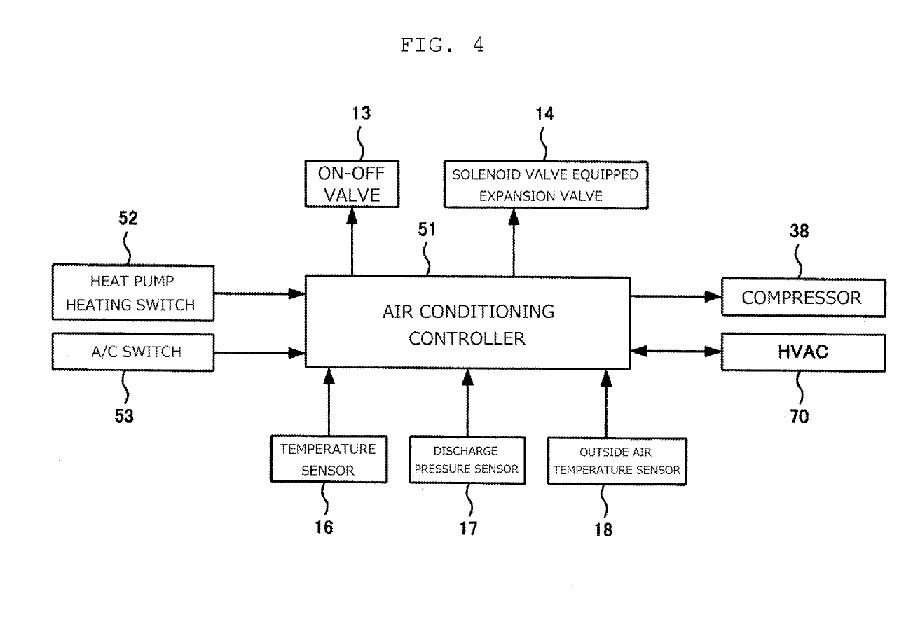

FIG. 4 is a block diagram illustrating part of components of the air conditioning device for vehicle.

ON-OFF valve 13 switches to open or close the refrigerant pipe under control of air conditioning controller 51. Further, solenoid valve equipped expansion valve 14 is a valve which is switched to open or close the refrigerant pipe under control of air conditioning controller 51, and functions as an expansion valve when the refrigerant pipe is switched to open.

Temperature sensor 16 detects a temperature of a coolant guided to first water-refrigerant heat exchanger 11, and notifies air conditioning controller 51 of the detected temperature of the coolant.

Discharge pressure sensor 17 detects a pressure of the refrigerant discharged from compressor 38, and notifies air conditioning controller 51 of the detected discharge pressure.

Outside air temperature sensor 18 detects an outside air temperature, and notifies air conditioning controller 51 of the detected outside air temperature.

Compressor 38 is driven by power of an engine or electricity under control of air conditioning controller 51, and compresses a suctioned refrigerant to a high-temperature and high-pressure refrigerant and discharges the refrigerant.

Air conditioning controller 51 performs normal driving determination control based on the coolant temperature notified from temperature sensor 16 and the discharge pressure of the refrigerant notified from discharge pressure sensor 17. The normal driving determination control refers to control of avoiding that compressor 38 is driven when a negative pressure is produced, and control of avoiding that compressor 38 is abnormally driven by detecting leakage of the refrigerant.

Heat pump heating switch 52 is an operation switch which can be operated by a user. Air conditioning controller 51 can determine that it is necessary to make a transition to the heat pump heating mode in the case where heat pump heating switch 52 has been operated to switch to ON.

A/C (air conditioning) switch 53 is an operation switch which can be operated by the user, and is a switch which gives an instruction to activate the heat pump for cooling or dehumidifying. Air conditioning controller 51 can determine that it is necessary to make a transition to the cooling mode or the temperature adjusting mode in the case where A/C switch 53 has been operated to switch to ON.

HVAC 70 is disposed at a vehicle interior side of a partition wall (firewall) which partitions an engine room and the interior of the vehicle, and is not illustrated. Further, HVAC 70 includes air-blast fan F1, evaporator 48 and heater core 44 which are disposed in order from an upstream side to a downstream side in an air-blast path of this fan F1, and door 44a. Furthermore, HVAC 70 adjusts air-conditioning of the interior of the vehicle by causing evaporator 48 and heater core 44 to blow air whose temperature has been adjusted, to the interior of the vehicle. HVAC 70 obtains an air conditioning control signal from air conditioning controller 51, and controls an opening of door 44a and a number of times of rotations of fan F1 according to the air conditioning control signal.

### <Operation of Air Conditioning Device for Vehicle>

Next, an operation of air conditioning controller 51 will be described.

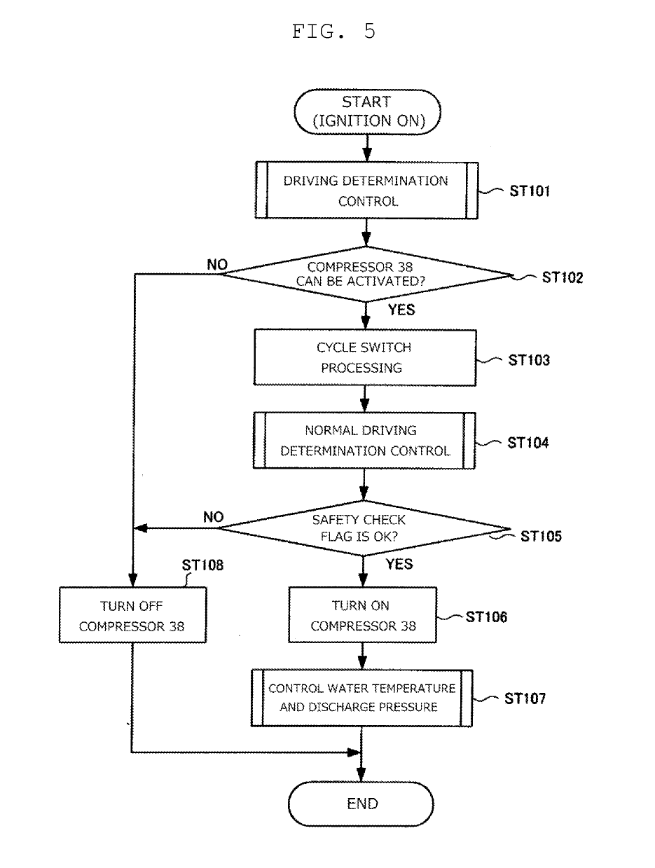

FIG. 5 is a flowchart illustrating an operation process of an air conditioning controller. In addition, the process from a start to an end illustrated in FIG. 5 is repeated at a certain cycle such as a cycle of 500 ms.

Air conditioning controller 51 starts operating when an ignition of the vehicle is turned on, and performs driving determination control of determining which one of the cooling refrigerant circuit and the heating refrigerant circuit is used (step ST101).

Air conditioning controller 51 determines whether or not compressor 38 can be activated (step ST102), and when compressor 38 can be activated (step ST102: YES), air conditioning controller 51 performs cycle switch processing of switching the refrigerant circuit to one of the cooling refrigerant circuit and the heating refrigerant circuit (step ST103).

Air conditioning controller 51 performs the normal driving determination control (step ST104), and determines whether or not a safety check flag is OK (step ST105).

When the safety check flag is OK (step ST105: YES), air conditioning controller 51 turns on compressor 38 (step ST106), controls a water temperature and a discharge pressure (step ST107) and finishes the operation. In step ST107, air conditioning controller 51 performs control of maintaining a coolant at a predetermined temperature (e.g. 60° C. to 65° C.), and performs control of keeping the discharge pressure at a predetermined pressure (e.g. 3.0 [MPa]) or less.

When determining in step ST102 that compressor 38 cannot be activated (step ST102: NO) and when determining in step ST105 that the safety check flag is NG (step ST105: NO), air conditioning controller 51 turns off compressor 38 and finishes the operation.

### <Driving Determination Control>

Next, the above-described driving determination control of air conditioning controller 51 will be described.

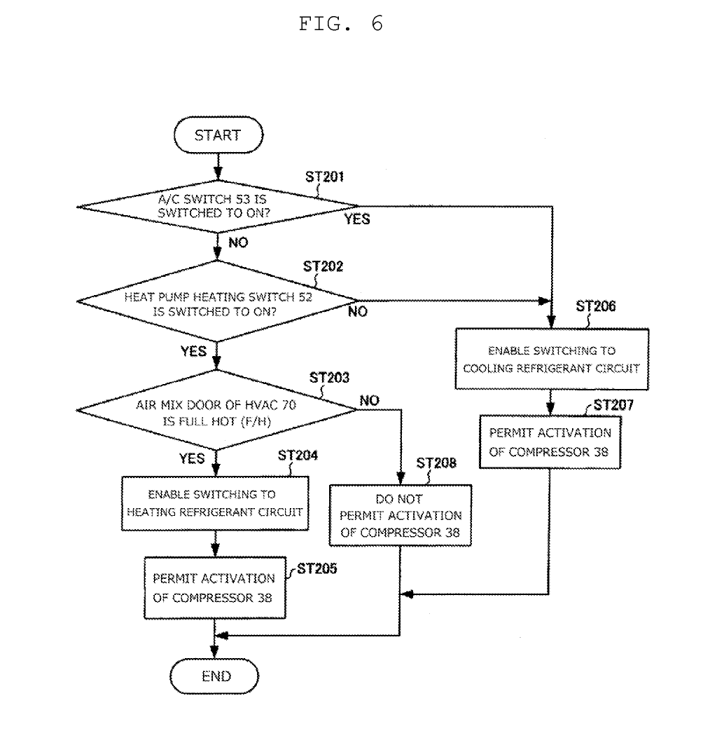

FIG. 6 is a flowchart illustrating a process of the driving determination control of the air conditioning controller illustrated in FIG. 5.

Air conditioning controller 51 determines whether or not A/C switch 53 has been operated to switch to ON (step ST201) and, in the case where A/C switch 53 has not been operated to switch to ON (step ST201: NO), air conditioning controller 51 determines whether or not heat pump heating switch 52 has been operated to switch to ON (step ST202).

In the case where heat pump heating switch 52 has been operated to switch to ON (step ST202: YES), air conditioning controller 51 determines whether or not the air mix door of HVAC 70 is full hot (F/H) (step ST203).

When the air mix door of HVAC 70 is full hot (step ST203: YES), the interior of the vehicle needs to be warmed at maximum, and therefore air conditioning controller 51 enables switching to the heating refrigerant circuit (step ST204), permits activation of compressor 38 (step ST205), and finishes the driving determination control.

In the case where A/C switch 53 has been operated to switch to ON in step ST201 (step ST201: YES), and in the case where heat pump heating switch 52 has not been operated to switch to ON in step ST202 (step ST202: NO), air conditioning controller 51 enables switching to the cooling refrigerant circuit (step ST206), permits activation of compressor 38 (step ST207), and finishes the driving determination control.

When the air mix door of HVAC 70 is not full hot in step ST203 (step ST203: NO), air conditioning controller 51 does not permit activation of compressor 38 (step ST208), and finishes the driving determination control.

### <Another Process of Driving Determination Control>

Next, another process of the above-described driving determination control of air conditioning controller 51 will be described.

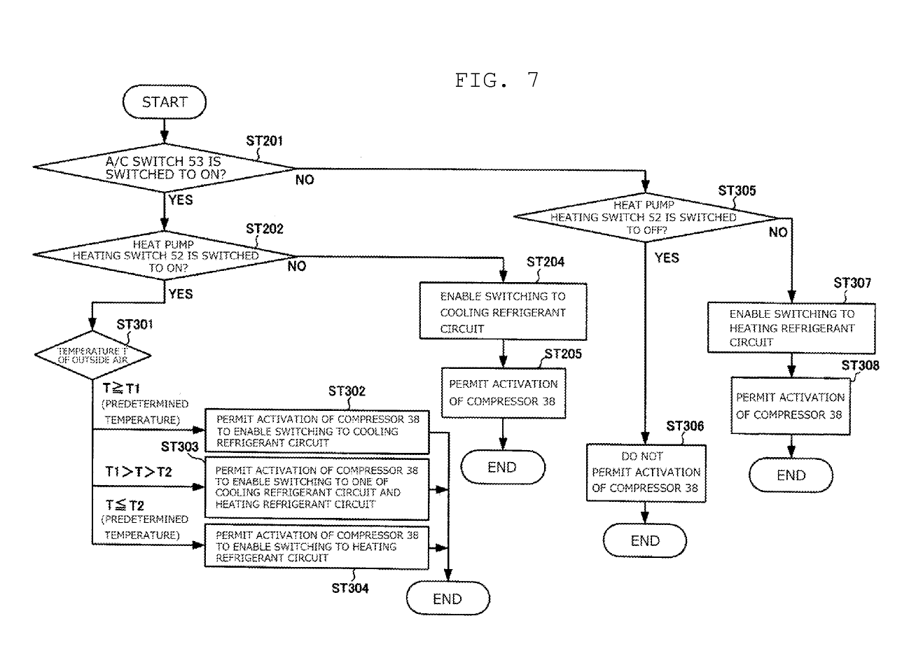

FIG. 7 is a flowchart illustrating another process of the driving determination control of the air conditioning controller illustrated in FIG. 5.

In the case where heat pump heating switch 52 has been operated to switch to ON in step ST202 (step ST202: YES), air conditioning controller 51 obtains outside air temperature T from outside air temperature sensor 18, and performs threshold determination on outdoor temperature T (step ST301).

When outside air temperature T is predetermined temperature T1 or more (T≧T1), air conditioning controller 51 enables switching to the cooling refrigerant circuit, permits activation of compressor 38 (step ST302), and finishes the driving determination control.

Further, when outside air temperature T is less than predetermined temperature T1 and is higher than predetermined temperature T2 (T2<T1) (T1>T>T2), air conditioning controller 51 enables switching to one of the cooling refrigerant circuit and the heating refrigerant circuit, and permits activation of compressor 38 (step ST303).

Furthermore, when outside air temperature T is predetermined temperature T2 or less (T≦T2), air conditioning controller 51 enables switching to the heating refrigerant circuit and permits the activation of compressor 38 (step ST304).

In the case where A/C switch 53 has not been operated to switch to ON in step ST201 (step ST201: NO), air conditioning controller 51 determines whether or not heat pump heating switch 52 has been operated to switch to OFF (step ST305).

In the case where heat pump heating switch 52 has been operated to switch to OFF (step ST305: YES), air conditioning controller 51 does not permit the activation of compressor 38 (step ST306).

Meanwhile, in the case where heat pump heating switch 52 has not been operated to switch to OFF (step ST305: NO), air conditioning controller 51 enables switching to the heating refrigerant circuit (step ST307), and permits the activation of compressor 38 (step ST308).

### <Normal Driving Determination Control>

Next, the above-described normal driving determination control of air conditioning controller 51 will be described.

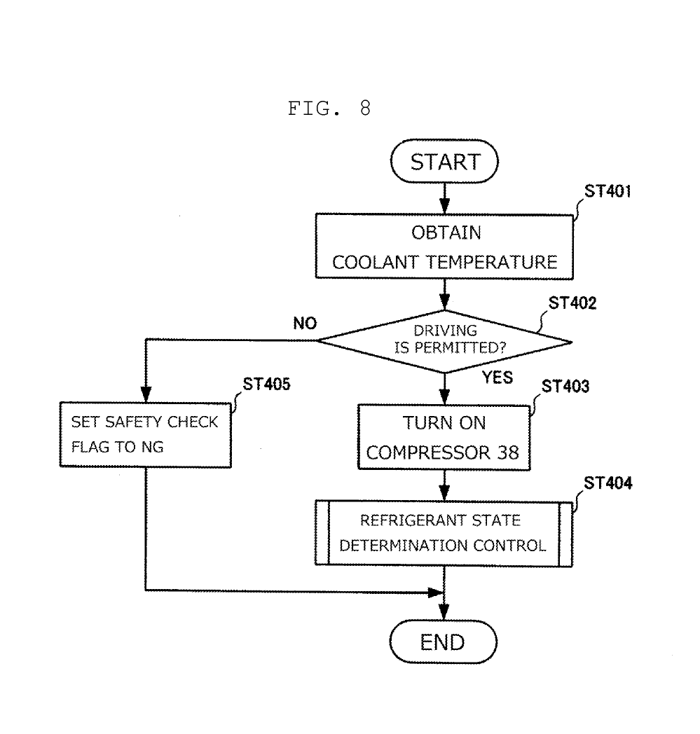

FIG. 8 is a flowchart illustrating a process of the normal driving determination control of the air conditioning controller illustrated in FIG. 5.

Air conditioning controller 51 obtains a coolant temperature from temperature sensor 16 (step ST401), and determines whether or not to permit driving of compressor 38 based on the obtained coolant temperature (step ST402). In this case, air conditioning controller 51 permits driving of compressor 38 at such a coolant temperature that the suction pressure of compressor 38 does not become a negative pressure. Further, a hysteresis is provided such that permission of driving is not frequently made or non-permission of driving is not frequently made at around a coolant temperature at which driving of compressor 38 is permitted. The hysteresis is provided, so that air conditioning controller 51 permits driving at T2° C. of the coolant temperature and does not permit driving at T1° C. (<T2° C.).

When driving of compressor 38 is permitted (step ST402: YES), air conditioning controller 51 turns on compressor 38 (step ST403), performs refrigerant state determination control (step ST404), and finishes the normal driving determination control. The refrigerant state determination control refers to control of resolving stagnation of a refrigerant and control of detecting leakage of a refrigerant in a heat pump cycle. This control will be described in detail below.

In the case where driving of compressor 38 has not been permitted in step ST402 (step ST402: NO), air conditioning controller 51 sets the safety check flag to NG (step ST405) and finishes the normal driving determination control.

Thus, air conditioning controller 51 permits driving of compressor 38 at such a coolant temperature that the suction pressure of compressor 38 does not become a negative pressure, and does not permit driving of compressor 38 at such a coolant temperature that the suction pressure becomes a negative pressure. Thus, air conditioning controller 51 determines whether or not to permit driving of compressor 38 based on the coolant temperature which is correlated with the suction pressure of the refrigerant of compressor 38 without a sensor which detects a suction pressure. Consequently, it is possible to efficiently avoid that the suction pressure of compressor 38 becomes the negative pressure.

### <Refrigerant State Determination Control>

Next, the above-described refrigerant state determination control will be described.

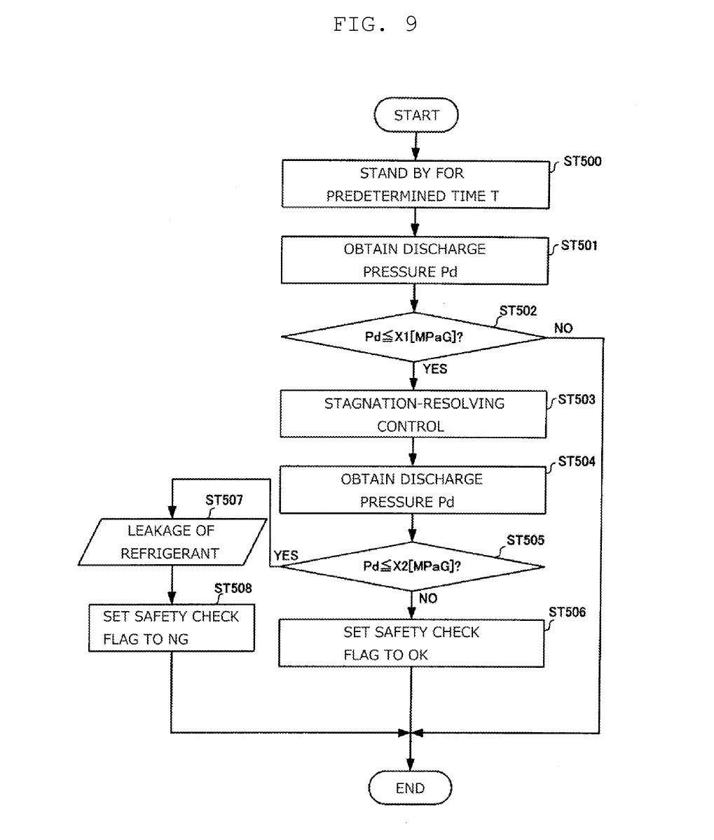

FIG. 9 is a flowchart illustrating a process of refrigerant state determination control illustrated in FIG. 8.

Air conditioning controller 51 stands by for predetermined time T after starting the refrigerant state determination control (step ST500). After the coolant is increased to such a temperature that the suction pressure does not become a negative pressure (step ST402: YES in FIG. 8), if compressor 38 is not driven for a predetermined time, the discharge pressure does not change. Hence, the refrigerant state determination control requires that compressor 38 is driven for predetermined time T. If compressor 38 is not driven for predetermined time T, in a pressure transient state, refrigerant leakage (step ST310) determination described below cannot be performed.

Air conditioning controller 51 obtains discharge pressure Pd of a refrigerant from discharge pressure sensor 17 (step ST501), and determines whether or not obtained discharge pressure Pd is predetermined threshold X1 [MPaG] or less (step ST502). In this regard, when discharge pressure Pd is threshold X1 or less, the refrigerant is likely to leak or stagnate. That is, threshold X1 is set to such a value that a refrigerant is likely to leak or stagnate.

When discharge pressure Pd exceeds threshold X1 (step ST502: NO), air conditioning controller 51 determines that the refrigerant is not likely to leak or stagnate, and finishes the refrigerant state determination control.

Meanwhile, when discharge pressure Pd is threshold X1 or less (step ST502: YES), air conditioning controller 51 determines that the refrigerant is likely to leak or stagnate, and performs stagnation-resolving control (step ST503).

Air conditioning controller 51 obtains discharge pressure Pd again from discharge pressure sensor 17 (step ST504), and determines whether or not obtained discharge pressure Pd is predetermined threshold X2 [MPaG] or less (step ST505). In addition, threshold X2 may take the same value as a value of threshold X1 and may take a different value.

When a predetermined time (a time of the stagnation-resolving control (step ST503)) passes after compressor 38 is driven, and then discharge pressure Pd exceeds threshold X2 (step ST505: NO), air conditioning controller 51 determines that the stagnation has been resolved, sets the safety check flag to OK (step ST506), and finishes the refrigerant state determination control. On the other hand, when a predetermined time (the time of the stagnation-resolving control (step ST503)) passes after compressor 38 is driven, and discharge pressure Pd is threshold X2 or less (step ST505: YES), air conditioning controller 51 determines that the refrigerant leaks since discharge pressure Pd does not rise even though the stagnation-resolving processing is performed, and stores refrigerant leakage information in a memory (step ST507). The stored refrigerant leakage information is read by air conditioning controller 51, and is used to process error notification.

Air conditioning controller 51 sets the safety check flag to NG (step ST508), and finishes the refrigerant state determination control.

Thus, air conditioning controller 51 determines that the refrigerant is likely to leak or stagnate when discharge pressure Pd of the refrigerant is threshold X1 or less. However, at this point of time, it is not possible to accurately distinguish whether stagnation has lowered the discharge pressure or leakage of the refrigerant has lowered the discharge pressure. Air conditioning controller 51 performs stagnation-resolving control in this state, and, when discharge pressure Pd is still threshold X2 or less even though the stagnation-resolving control is performed, air conditioning controller 51 determines that the refrigerant leaks. Consequently, it is possible to more accurately detect leakage of the refrigerant.

Thus, air conditioning device for vehicle 1 according to the first exemplary embodiment detects a temperature of a coolant which circulates in first water-refrigerant heat exchanger 11 and the cooling path of engine cooling portion 40 and is guided to first water-refrigerant heat exchanger 11, and determines whether or not to permit driving of compressor 38 based on the detected temperature of the coolant.

According to the above exemplary embodiment, driving of compressor 38 is permitted at such a coolant temperature that the suction pressure of compressor 38 does not become a negative pressure, and driving of compressor 38 is not permitted at such a coolant temperature that the suction pressure is a negative pressure. Consequently, a sensor which detects a suction pressure is not necessary.

Further, whether or not to permit driving of compressor 38 is determined based on a coolant temperature which is correlated with a suction pressure of the refrigerant of compressor 38. Consequently, it is possible to efficiently avoid that the suction pressure of compressor 38 becomes the negative pressure.

### Second Exemplary Embodiment

In an air conditioning device for vehicle which adopts a compressor as a common path and which switches between a heating refrigerant circuit and a cooling refrigerant circuit, refrigerant stagnation occurs in the cooling refrigerant circuit in heating. Therefore, the air conditioning device for vehicle needs to take a countermeasure for this stagnation (corresponding to stagnation-resolving control illustrated in FIG. 9 according to the first exemplary embodiment). This countermeasure will be more specifically described below. In addition, this countermeasure will be described below with reference to FIGS. 1 and 4 as preconditions used in the first exemplary embodiment.

### <Stagnation-Resolving Control Processing 1>

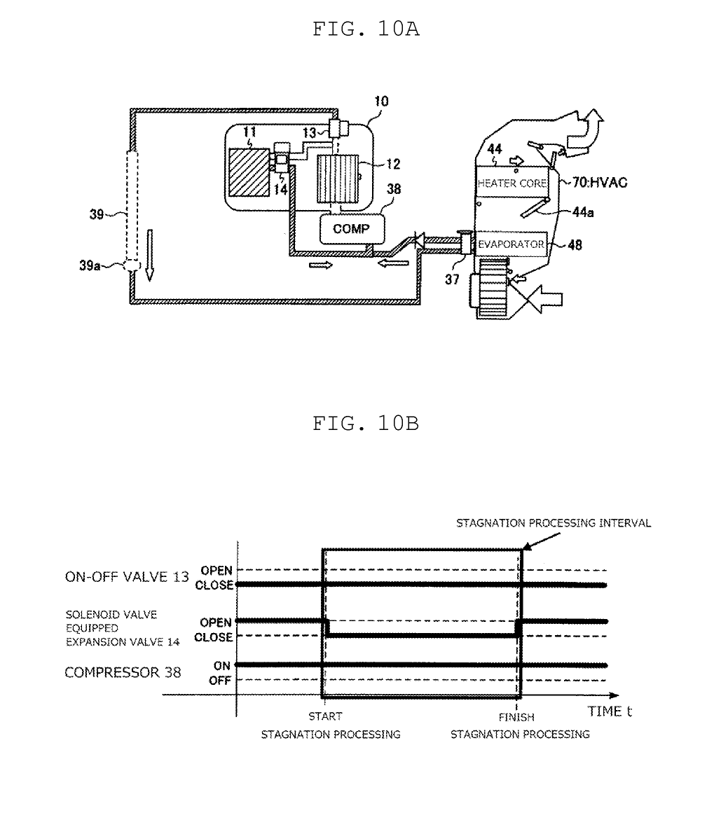

FIG. 10A and FIG. 10B are diagrams for illustrating stagnation-resolving control processing 1 according to the second exemplary embodiment of the present disclosure. According to stagnation-resolving control processing 1, air conditioning controller 51 in air conditioning device for vehicle 1 closes ON-OFF valve 13 and solenoid valve equipped expansion valve 14 in activation of a heat pump heating mode. FIG. 10A illustrates a refrigerant path (referred to as a “refrigerant stagnation-resolving refrigerant circuit” below). As is clear from FIG. 10A, too, in the refrigerant stagnation-resolving refrigerant circuit, feeding of the refrigerant from second water-refrigerant heat exchanger 12 to outside condenser 39 and first water-refrigerant heat exchanger 11 is interrupted.

FIG. 10B illustrates that a timing of opening or closing ON-OFF valve 13 and solenoid valve equipped expansion valve 14 and turning on and off compressor 38. As illustrated in FIG. 10B, in a stagnation processing interval from a start of stagnation processing to an end of the stagnation processing, air conditioning controller 51 closes ON-OFF valve 13 and solenoid valve equipped expansion valve 14 and turns on compressor 38. That is to say, the refrigerant stagnation-resolving refrigerant circuit illustrated in FIG. 10A is driven by compressor 38, so that it is possible to collect from a suction side the refrigerant which stagnates in first water-refrigerant heat exchanger 11 and second water-refrigerant heat exchanger 12. At a point of time at which the stagnation processing is finished, air conditioning controller 51 opens solenoid valve equipped expansion valve 14 to cause the refrigerant to flow in the refrigerant circuit passing through second water-refrigerant heat exchanger 12.

In addition, stagnation-resolving control processing 1 is effective at a start of driving of compressor 38 and in switching between cooling and heating.

### <Stagnation-Resolving Control Processing 2>

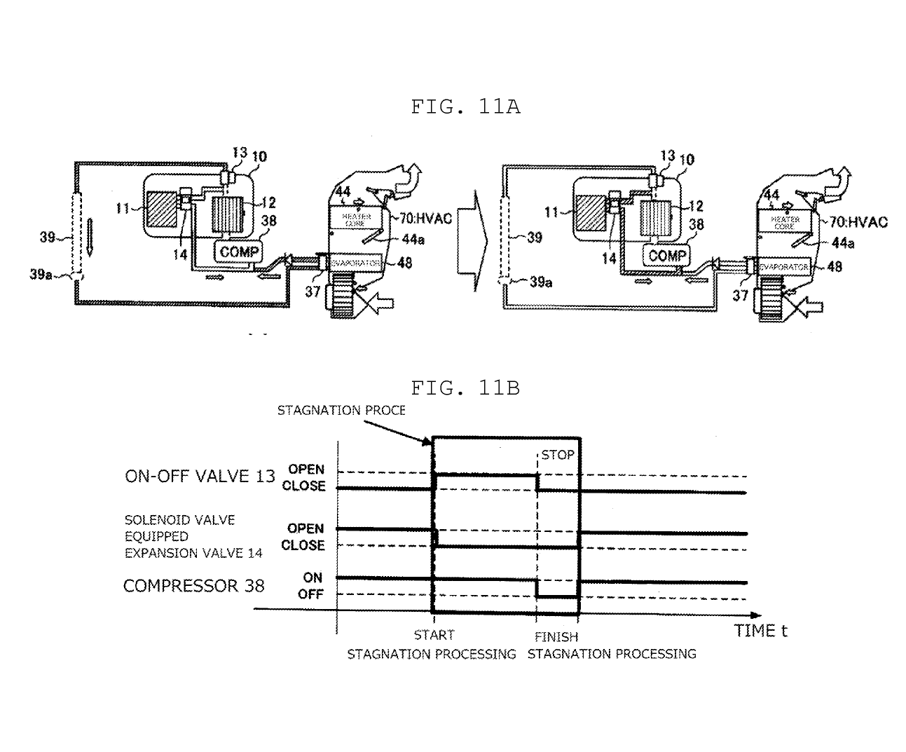

FIG. 11A and FIG. 11B are diagrams for illustrating stagnation-resolving control processing 2 according to the second exemplary embodiment of the present disclosure. According to stagnation-resolving control processing 2, in activation of a heat pump heating mode, air conditioning controller 51 in air conditioning device for vehicle 1 operates for a certain period of time a cooling mode in which a refrigerant flows to a cooling refrigerant circuit including outside condenser 39, compressor 38 and evaporator 48 as illustrated in the left part of FIG. 11A. Consequently, it is possible to collect the refrigerant which stagnates in first water-refrigerant heat exchanger 11 and second water-refrigerant heat exchanger 12, from the suction side of compressor 38.

Subsequently, as illustrated in the right part of FIG. 11A, air conditioning controller 51 switches a mode to a heat pump heating mode in which the refrigerant flows to the heating refrigerant circuit including second water-refrigerant heat exchanger 12, compressor 38, and first water-refrigerant heat exchanger 11.

FIG. 11B illustrates that a timing of opening or closing ON-OFF valve 13 and solenoid valve equipped expansion valve 14 and turning on and off the compressor. As illustrated in FIG. 11B, at a point of time at which the stagnation processing starts, air conditioning controller 51 opens ON-OFF valve 13, closes solenoid valve equipped expansion valve 14, turns on compressor 38 and switches the mode to the cooling mode. Subsequently, at a point of time at which the stagnation processing is finished, air conditioning controller 51 closes ON-OFF valve 13, opens solenoid valve equipped expansion valve 14, turns on compressor 38, and switches the mode to the heat pump heating mode.

In addition, stagnation-resolving control processing 2 is effective at a start of driving of compressor 38.

Thus, according to the second exemplary embodiment, in activation of the heat pump heating mode, stagnation-resolving control processing 1 of driving compressor 38 in a state where a refrigerant discharge side of compressor 38 is interrupted is performed. Alternatively, in activation of the heat pump heating mode, stagnation-resolving control processing 2 of causing a refrigerant to flow to the cooling refrigerant circuit, driving compressor 38 and then causing the refrigerant to flow to the heating refrigerant circuit is performed. Consequently, it is possible to collect the refrigerant which stagnates in first water-refrigerant heat exchanger 11 and second water-refrigerant heat exchanger 12.

The exemplary embodiment of the present disclosure has been described above.

In addition, an example where the refrigerant circuit employs the configuration illustrated in FIG. 1 has been described in the above exemplary embodiments. However, the disclosure which prevents a suction pressure of a compressor from becoming a negative pressure is not limited to the configuration illustrated in FIG. 1, and only needs to adopt a refrigerant circuit including first water-refrigerant heat exchanger 11, compressor 38, heater core 44, temperature sensor 16, and air conditioning controller 51.

Further, the disclosure which resolves stagnation only needs to employ a configuration of switching between the cooling refrigerant circuit and the heating refrigerant circuit which shares the compressor with this cooling refrigerant circuit.

Furthermore, in the above exemplary embodiments, air conditioning controller 51 determines whether or not to permit driving of compressor 38 based on a temperature detected by temperature sensor 16. However, air conditioning controller 51 may estimate a refrigerant suction pressure of compressor 38 based on the temperature detected by temperature sensor 16, and determine whether or not to permit driving of compressor 38 based on this estimated refrigerant suction pressure. For example, air conditioning controller 51 determines permission of driving of compressor 38 when the estimated refrigerant suction pressure is a predetermined pressure or more.

Further, the engine has been described as an example of a heating component of the vehicle in the above exemplary embodiments. However, the heating component of the vehicle may adopt various heating components such as an electric motor of an electric vehicle for driving or a rechargeable battery which supplies power for driving.

Disclosures of the description, the drawings and the abstract included in Japanese Patent Application No. 2013-155185 filed on Jul. 26, 2013, are entirely incorporated in this application.

The present disclosure can be used for an air conditioning device for vehicle which is mounted on various vehicles such as engine cars, electric vehicles, or HEV cars.

What is claimed is:

1. An air conditioning device for vehicle, the device comprising:
a first water-refrigerant heat exchanger which performs a heat exchange between a coolant and a low-temperature and low-pressure refrigerant, and vaporizes the refrigerant;
a compressor which compresses the refrigerant fed from the first water-refrigerant heat exchanger, to a high-temperature and high-pressure refrigerant, and discharges the refrigerant;
a heater core which heats an interior of a vehicle by using heat of the high-temperature and high-pressure refrigerant discharged by the compressor;
a temperature sensor which detects a temperature of the coolant circulating in the first water-refrigerant heat exchanger and a cooling path of a heat generating component of the vehicle, the temperature being detected when the coolant flows in the first water refrigerant heat exchanger; and
a controller which determines whether or not to permit driving of the compressor, based on the temperature detected by the temperature sensor.

2. The air conditioning device for vehicle according to claim 1, wherein, when the temperature detected by the temperature sensor is a threshold or more, the controller permits the driving of the compressor.

3. The air conditioning device for vehicle according to claim 2, further comprising a pressure sensor which detects a discharge pressure of the high-temperature and high-pressure refrigerant discharged by the compressor,
wherein, when a predetermined time passes after the compressor is driven and the discharge pressure detected by the pressure sensor does not rise to a predetermined pressure, the controller determines that there is leakage of the refrigerant.

4. The air conditioning device for vehicle according to claim 3, wherein the controller performs refrigerant stagnation-resolving processing, and, when the discharge pressure detected by the pressure sensor does not rise to the predetermined pressure after the refrigerant stagnation-resolving processing, the controller determines that there is the leakage of the refrigerant.

5. The air conditioning device for vehicle according to claim 1, further comprising a second water-refrigerant heat exchanger which performs a heat exchange between a high-temperature and high-pressure refrigerant and the coolant, and condenses the refrigerant,
wherein
the second water-refrigerant heat exchanger inputs the coolant from the cooling path of the heat generating component, feeds the coolant to the heater core and guides the high-temperature and high-pressure refrigerant discharged by the compressor, and
the heater core heats an air-blast to the interior of the vehicle by using the coolant fed by the second water-refrigerant heat exchanger.

6. The air conditioning device for vehicle according to claim 1, wherein the temperature sensor detects the temperature of the coolant guided to the first water-refrigerant heat exchanger.

7. An air conditioning device for vehicle, the device comprising:
a first water-refrigerant heat exchanger which performs a heat exchange between a low-temperature and low-pressure refrigerant and a coolant for heat transportation, and vaporizes the refrigerant;
a second water-refrigerant heat exchanger which performs a heat exchange between a high-temperature and high-pressure refrigerant and the coolant for heat transportation, and condenses the refrigerant;
a compressor which compresses the refrigerant;
an evaporator which performs a heat exchange between a low-temperature and low-pressure refrigerant and suction air to be fed to an interior of a vehicle; a condenser which releases heat from the high-temperature and high-pressure refrigerant, and condenses the refrigerant;
a switch which can switch among a state where the refrigerant flows to a heating refrigerant circuit including the second water-refrigerant heat exchanger, the compressor, and the first water-refrigerant heat exchanger, a state where the refrigerant flows to a cooling refrigerant circuit including the condenser, the compressor, and the evaporator, and a state of a refrigerant stagnation-resolving refrigerant circuit in which the feeding of the refrigerant from the second water-refrigerant heat exchanger to the condenser and the first water-refrigerant heat exchanger is interrupted; and
a controller which, in activation of a heat pump heating mode where the second water-refrigerant heat exchanger heats the coolant to heat the interior of the vehicle, performs refrigerant stagnation-resolving processing of switching the switch such that the refrigerant flows to the refrigerant stagnation-resolving refrigerant circuit.

8. An air conditioning device for vehicle, the device comprising:
a first water-refrigerant heat exchanger which performs a heat exchange between a low-temperature and low-pressure refrigerant and a coolant for heat transportation, and vaporizes the refrigerant;
a second water-refrigerant heat exchanger which performs a heat exchange between a high-temperature and high-pressure refrigerant and the coolant for heat transportation, and condenses the refrigerant;
a compressor which compresses the refrigerant;
an evaporator which performs a heat exchange between a low-temperature and low-pressure refrigerant and suction air to be fed to an interior of a vehicle;
a condenser which releases heat from the high-temperature and high-pressure refrigerant, and condenses the refrigerant;
a switch which can switch between a state where the refrigerant flows to a heating refrigerant circuit including the second water-refrigerant heat exchanger, the compressor, and the first water-refrigerant heat exchanger, and a state where the refrigerant flows to a cooling refrigerant circuit including the condenser, the compressor, and the evaporator; and
a controller which, in activation of a heat pump heating mode where the second water-refrigerant heat exchanger heats the coolant to heat the interior of the vehicle, performs refrigerant stagnation-resolving processing of switching the switch such that the refrigerant flows to the cooling refrigerant circuit, driving the compressor, and then switching the switch such that the refrigerant flows to the heating refrigerant circuit.

9. An air conditioning device for vehicle according to claim 8, the device comprising:
an air conditioning switch which can be operated by a user;
a heat pump heating switch which can be operated by the user; and
a controller which receives an air conditioning control signal from an HVAC (Heating, Ventilation, and Air Conditioning),
wherein the controller
switches the switch such that the refrigerant flows to the cooling refrigerant circuit when the air conditioning switch is switched to on,
switches the switch such that the refrigerant flows to the heating refrigerant circuit when the air conditioning switch is switched to off, the heat pump heating switch is switched to on, and the air conditioning control signal indicates that a mix door of the HVAC is full-hot, and
switches the switch such that the refrigerant flows to the cooling refrigerant circuit when the air conditioning switch is switched to on and the heat pump heating switch is switched to off.

10. An air conditioning device for vehicle according to claim 8, the device comprising:
an air conditioning switch which can be operated by a user;
a heat pump heating switch which can be operated by the user; and
an outside air temperature sensor which detects an air temperature outside of the vehicle,
wherein, when the air conditioning switch is switched to on and the heat pump heating switch is switched to on, the controller determines whether or not to switch the switch such that the refrigerant flows to one of the cooling refrigerant circuit and the heating refrigerant circuit based on the temperature detected by the outside air temperature sensor.

11. The air conditioning device for vehicle according to claim 10, wherein the controller
determines to switch the switch such that the refrigerant flows to the cooling refrigerant circuit when the air temperature detected by the outside air temperature sensor is a first predetermined value or more, and
determines to switch the switch such that the refrigerant flows to the heating refrigerant circuit when the air temperature detected by the outside air temperature sensor is less than a second predetermined value smaller than the first predetermined value.
